(19) United States
(12) Patent Application Publication
(10) Pub. No.: US 2019/0382952 A1
(43) Pub. Date: Dec. 19, 2019

(54) METHOD FOR PRODUCING A THERMALLY INSULATING LAYER

(71) Applicant: EVONIK DEGUSSA GMBH, Essen (DE)

(72) Inventors: Matthias GEISLER, Nörten-Hardenberg (DE); Uwe NUMRICH, Cross-Zimmern (DE); Ulrich BOES, Frankfurt a.M. (DE)

(73) Assignee: EVONIK DEGUSSA GMBH, Essen (DE)

(21) Appl. No.: 16/484,368

(22) PCT Filed: Feb. 7, 2018
(86) PCT No.: PCT/EP2018/053056

§ 371 Date: Aug. 7, 2019

Related U.S. Application Data
(60) Provisional application No. 62/482,986, filed on Apr. 7, 2017.

(30) Foreign Application Priority Data
Feb. 9, 2017 (EP) 17155384.5

(51) Int. Cl. D06N 3/00; F16L 59/02

(52) U.S. Cl. CPC D06N 3/0002; D06N 2209/065; D06N 2211/06; F16L 59/028

(57) ABSTRACT

Process for the simple and practical application of a relatively thick heat-insulating layer to a surface to be insulated by: (a) applying a porous substrate consisting of a spacer fabric to the surface of an article, which surface is to be insulated; (b) filling the porous substrate with a heat-insulating formulation; (c) curing the formulation filled into the porous substrate.

The present invention relates to a process for applying a heat-insulating layer to a surface to be insulated, more particularly that of pipes.

Effective heat insulation of houses, industrial plants, pipelines and suchlike is an important economic problem. The majority of insulation materials based on organic substances, such as polyurethane foams, are combustible and only usable at restricted temperatures. These disadvantages are not exhibited by the hitherto less widespread heat-insulation materials based on inorganic oxides, for example highly porous silicon dioxide.

The so-called aerogels, and also precipitated or fumed silicas, are customarily used as the basis of such silicon dioxide-based heat-insulating materials. Further information on these silica types can be found in Ullmann's Encyclopedia of Industrial Chemistry, “Silica” chapter, published online on Apr. 15, 2008, DOI: 10.1002/14356007.a23_583.pub3.

The above-described heat-insulating materials can, for example, be applied in the form of a coating to the surface to be insulated.

WO 03/064025 A1 describes such heat-insulating coatings and the application thereof. An appropriate composition containing water-based polymerizable acrylate binders, hydrophobic aerogels and optionally further additives, such as IR opacifiers, is customarily applied in a layer thickness of 1 mm or less and cured, for example thermally.

A thicker heat-insulation layer which would ensure better heat insulation can, by means of a composition as disclosed in WO 03/064025 A1, be applied only in multiple work steps in a successive manner.

Both the pulverulent or granular heat-insulating materials and the mixtures thereof with other components or compositions based thereon can be enclosed in a supporting construction, for example between an inner pipe and outer pipe. For example, WO 99/05447 discloses this kind of pipe heat insulation, in which a composition of spherical particles, a foam and binder is enclosed between two pipes placed inside one another. US 2006/027227 A1 describes a pipe-in-pipe system which is similar in principle and which is filled with aerogel particles.

U.S. Pat. No. 3,574,027 A discloses a process for producing a heat-insulation body, in which multiple mineral-fibre mats impregnated with polymerizable organic substances are joined to one another with an aqueous dispersion of a heat-insulating material, followed by heating of the thus obtained multilayer system, which heating leads to the polymerization of the binding material, vaporization of the water and, as a result, curing of the thus obtained heat-insulation body. Because of its complexity, this multi-step process can be used only in a very limited manner for the heat insulation of the pipes and other non-planar articles.

U.S. Pat. No. 6,472,067 B1 discloses a process for producing non-combustible cured composites by:

a) producing a polyalkylsiloxane polymer;

b) impregnating a fibre material with said polymer;

c) drying and thermally curing the polymer.

WO 2016/171558 discloses a process for applying a heat-insulating aerogel-containing coating to a porous substrate such as membranes, foams and suchlike, comprising the following steps:

a) producing a silica sol by hydrolysis of a trialkoxysilane;

b) impregnating a porous substrate with said sol;

c) gelling the silica sol to form a gel;

d) replacing water with an organic solvent;

e) drying.

None of the processes known from the prior art allows simple and practical application of a relatively thick heat-insulating layer to the surface to be insulated. It is an object of the present invention to solve this problem. More particularly, it is an object of this invention to provide a simple-to-perform process suitable, inter alia, for factory production, for making repairs and for upgrading of stock. It is a further object of the invention to provide a process for applying a heat-insulating layer to a non-horizontally positioned, for example inclined, surface or to a lower surface of a horizontally positioned surface. In these cases, a typical prior-art-known non-cured heat-insulating coating of the surface to be insulated would flow off or drip off. For the same reason, it is also a further object of the invention to provide a process for applying a heat-insulating layer to a highly uneven, curved or rounded surface.

These objects have been achieved by a process for applying a heat-insulating layer to a surface of an article, which surface is to be insulated, comprising the following steps:

a) applying a porous substrate consisting of a spacer fabric to the surface to be insulated;

b) filling the porous substrate applied in step a) with a heat-insulating formulation;

c) curing the formulation filled in step b).

In principle, it is possible to insulate any possible surface of an article in accordance with the process according to the invention. The surface to be insulated can be planar, curved, rounded, angular, or of some other nature; it can be smooth or rough, uneven. The surface to be insulated can be spatially positioned in any manner, for example it can be horizontal, vertical or inclined in relation to the Earth's surface. Preferably, the article having the surface to be insulated is selected from the group consisting of wall, ceiling, floor, plate, pipeline and pipe. Particularly preferably, the process according to the invention can be used to insulate pipelines and/or pipes.

Owing to its appropriate form and nature, the porous substrate used in the process according to the invention can secure and hold the heat-insulating layer before and during the curing such that no premature deformation takes place and a thick heat-insulating layer can be applied.

The porous substrate used in the process according to the invention is preferably flexible and can thus be slightly deformed. Such porous substrates can be best adapted to the shape of the surface to be insulated, making it possible to ensure better heat insulation. For example, it is possible without any problems for a pipe or similar articles to be insulated to be wrapped with the porous substrate.

The porosity P of a material is often expressed as the ratio of cavity volume to total volume of said material and can thus assume values of from 0 to 1. The porosity P of the porous substrate in the context of the present invention can be from 0.3 to 1; particularly preferably, it is from 0.5 to 0.99, very particularly preferably from 0.7 to 0.98. The porous substrate can be selected from the list consisting of synthetic polymers, cellulose-based fibres, cotton, wool, silk, mineral wool, glass wool, metals, carbon fibres and the combinations thereof.

The porous substrate consists of a spacer fabric. Spacer fabrics are double-surface textiles or fabrics in which the relevant textile or fabric surfaces are kept apart by binding threads having a spacing effect, known as pile threads. Spacer fabrics are knit fabrics or knitted fabrics which have been three-dimensionally expanded. Spacer fabrics are distinguished by a light, air-permeable structure, and spacer fabrics are elastic in the direction of their thickness owing to the spacer threads running between both fabric plies.

The spacer fabric can have a mesh size of from 2 to 100 mm, preferably from 2 to 30 mm, particularly preferably from 5 to 20 mm.

In a particularly preferred embodiment of the invention, the spacer fabric has a compression stress in accordance with DIN EN ISO 3386-1 of greater than 100 Pa, preferably of greater than 300 Pa, particularly preferably of greater than 500 Pa, very particularly preferably of from 1 kPa to 500 kPa. It is very particularly advantageous when the spacer fabric has a compression stress in accordance with DIN EN ISO 3386-1 of greater than 3 kPa and a mesh size of from 2 to 30 mm.

The spacer fabric can have a material density of from 5 to 400 kg/m³, preferably from 10 to 200 kg/m³, particularly preferably from 15 to 150 kg/m³, very particularly preferably from 25 to 100 kg/m³.

The appropriate design of the porous substrate should be optimally tailored to the elements of the entire system: insulation thickness, formulation composition, area of use and so on. Here, it is possible through the selection of the porous substrate to select an optimal configuration of the number, shape and size of the porous-substrate-forming elements and also of the size and shape and design of the cover surface openings for introducing the heat-insulating formulation and for ensuring the fixation thereof in the porous substrate. Preferably used in the cover surface are openings which are larger by not more than a factor of 10 than the largest particles of the fillers and other solids additives of the formulation. It is particularly advantageous when said openings have some kind of automatic closure, for example threads which push back into a middle, tighter position as a result of inherent tension (diode effect). This makes it possible to achieve effective filling of the supporting structure. The distances between the cover layers can also be realized by forms other than spacer fabrics, for example webs. Also, the spacer fabric does not necessarily need to have two cover surfaces; for example, it can also have none or one.

If the surface to be insulated is positioned in an easily accessible, planar, even, horizontal manner and is situated on the upper side of the article to be insulated, the porous substrate can be easily placed thereon, directly followed by steps b) and c) of the process according to the invention. However, in many other cases, it may be useful to attach the porous substrate to the surface to be insulated before carrying out steps b) and c). The porous substrate used in the process according to the invention can be attached mechanically and/or by means of an aid to the surface to be insulated. For example, mechanical attachment can be achieved by bending or wrapping the porous substrate around the article to be insulated. Mechanical attachment of the porous substrate to the surface to be insulated can also be ensured by means of aids, for example nails, staples and suchlike. In addition, the porous substrate can be bonded to the surface to be insulated by means of the appropriate adhesives.

After the application and the optional attachment of the porous substrate to the surface to be insulated in step a) of the process according to the invention, there takes place in step b) the filling of the porous substrate with a heat-insulating formulation. The porous substrate can, as a result, be partly or completely filled with a heat-insulating formulation. The porous substrate can be filled in any appropriate manner, for example by brushing, spreading, smearing, squeezing of the heat-insulating formulation from a tube and so on.

A heat-insulating formulation suitable for carrying out the process according to the invention can contain at least one solvent and/or binder and/or filler.

In this connection, the solvent can be selected from the group consisting of water, alcohols, aliphatic and aromatic hydrocarbons, ethers, esters, aldehydes, ketones and the mixtures thereof. For example, the solvent used can be water, methanol, ethanol, propanol, butanol, pentane, hexane, benzene, toluene, xylene, diethyl ether, methyl tert-butyl ether, ethyl acetate, acetone. Particularly preferably, the solvents used in the heat-insulating formulation have a boiling point of less than 300° C., particularly preferably less than 200° C. Such relatively volatile solvents can be easily evaporated or vaporized during the curing of the heat-insulating formulation in step c) of the process according to the invention.

The heat-insulating formulation used in the process according to the invention can contain at least one binder, which joins the individual parts of the cured formulation to one another and optionally to one or more fillers and/or other additives and can thus improve the mechanical properties of the cured formulation. Such a binder can contain organic or inorganic substances. The binder preferably contains reactive organic substances. Organic binders can, for example, be selected from the group consisting of (meth)acrylates, alkyd resins, epoxy resins, gum Arabic, casein, vegetable oils, polyurethanes, silicone resins, wax, cellulose glue. Such reactive organic substances can lead to the curing of the heat-insulating formulation used, for example by polymerization, crosslinking reaction or another type of chemical reaction, in step c) of the process according to the invention. The curing in step c) of the process according to the invention can, for example, take place thermally or under the action of UV radiation or other radiation.

In addition to the organic binder or as an alternative thereto, the heat-insulating formulation used in the process according to the invention can contain inorganic curable substances. Inorganic binders, also referred to as mineral binders, have essentially the same task as the organic binders, that of joining additive substances to one another. Furthermore, inorganic binders are divided into non-hydraulic binders and hydraulic binders. Non-hydraulic binders are water-soluble binders such as calcium lime, Dolomitic lime, gypsum and anhydrite, which only cure in air. Hydraulic binders are binders which cure in air and under water and are water-insoluble after the curing. They include hydraulic limes, cements, masonry cements.

The curing taking place in step c) of the process according to the invention is achieved by at least partial polymerization and/or vaporization of the solvent. Depending on the system used, this step can preferably take place at a temperature of from 0 to 500° C., particularly preferably from 5 to 400° C., very particularly preferably from 10 to 300° C. The curing in step c) can take place in air or with exclusion of oxygen, for example under a protective-gas atmosphere of nitrogen or carbon dioxide. Said step can take place under standard pressure or under a reduced pressure, for example under vacuum.

Besides the solvents and/or binders, the heat-insulating formulation used in the process according to the invention can contain one or more porous heat-insulating fillers. The heat-insulating formulation can preferably contain silicon dioxide. Said heat-insulating formulation particularly preferably contains at least one substance selected from the group consisting of precipitated silicas, fumed silicas, aerogels, xerogels and perlites. Very particularly preferably, the heat-insulating formulation contains fumed silicas. Fumed silicas are prepared by means of flame hydrolysis or flame oxidation. This involves oxidizing or hydrolysing hydrolysable or oxidizable starting materials, generally in a hydrogen/oxygen flame. Starting materials used for pyrogenic methods include organic and inorganic substances. Silicon tetrachloride is particularly suitable. The hydrophilic silica thus obtained is amorphous. Fumed silicas are generally in aggregated form. “Aggregated” is understood to mean that what are called primary particles, which are formed at first in the genesis, become firmly bonded to one another later in the reaction to form a three-dimensional network. The primary particles are very substantially free of pores and have free hydroxyl groups on their surface. Such hydrophilic silicas can, as required, be hydrophobized, for example by treatment with reactive silanes. Both hydrophilic and hydrophobic silicas can be used as fillers in the process according to the invention.

The heat-insulating formulation used in the process according to the invention can contain at least one IR opacifier. Such an IR opacifier reduces the infrared transmittance of a heat-insulating material and thus minimizes the heat transfer due to radiation. Preferably, the IR opacifier is selected from the group consisting of silicon carbide, titanium dioxide, zirconium dioxide, ilmenites, iron titanates, iron oxides, zirconium silicates, manganese oxides, graphites, carbon blacks and mixtures thereof. The particle size of the opacifiers is generally between 0.1 and 25 μm.

The heat-insulating formulation used in the process according to the invention can contain from 5 to 90% by weight, preferably from 7 to 70% by weight, particularly preferably from 10 to 60% by weight, of a binder, from 20 to 95% by weight, preferably from 25 to 80% by weight, particularly preferably from 30 to 70% by weight, of a silica, and from 5 to 50% by weight, preferably from 10 to 40% by weight, particularly preferably from 15 to 30% by weight, of an IR opacifier.

The heat-insulating layer after curing in step c) of the process according to the invention preferably has a thickness of more than 1 mm; said thickness is preferably from 1 to 200 mm, particularly preferably from 2 to 150 mm, very particularly preferably from 3 to 100 mm.

The cured heat-insulating layer producible by the process according to the invention is preferably not open-pored and is flush with the article to be insulated. Such a closed nature of the heat-insulating material prevents the liquids, especially water, from penetrating into the inner structure of the insulation layer and brings technical advantages in the use of such insulation materials.

If needed, it is possible before step a) of the process according to the invention to apply a primer to the surface to be insulated, for example as additional corrosion protection. Likewise, it is possible after the curing in step c) of the process according to the invention to apply a final top layer, top coating, in order to improve the appearance or other properties of the insulated surface.

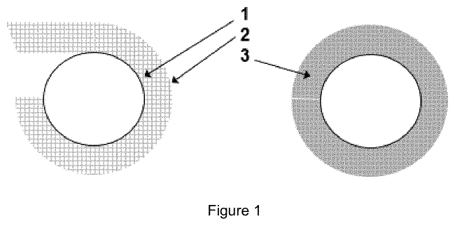

The invention will be more particularly elucidated below with reference to FIG. 1, which depicts a specific embodiment of the present invention, which embodiment is particularly suitable for the heat insulation of a pipe. This greatly simplified drawing is intended to give a complete overview of the process steps according to the invention:

a) A suitable porous substrate (2) is placed onto the surface of the pipe (1) to be insulated and is attached there, for example by means of adhesive bonding;

b) The porous substrate is filled with a heat-insulating formulation (3);

c) Finally, the heat-insulating formulation in the porous substrate cures directly on the surface of the pipe to be insulated.

### EXAMPLE 1

Preparing Heat-Insulating Formulation 1:

Acronal® Eco 6716 (500 g, manufacturer: BASF) and deionized water (50 g) were mixed in a beaker with a 50 mm propeller stirrer at a stirring speed of 750 rpm for 5 minutes. Enova® Aerogel IC 3110 (100 g, manufacturer: Cabot) was added to the water/Acronal® mixture at an addition rate of 10 g of aerogel per minute. The resultant mixture was stirred at a stirring speed of 750 rpm for a further 10 minutes. The heat-insulating formulation thus obtained had a density of 464 g/l and a solid fraction of 54%.

Fabric Filling:

In this example, the spacer fabric from Muller Textiles called T5993-1000-1450-0001 and made of 100% polyester was used. This structure has one ply, a thickness of 10 mm, a basis weight of about 520 g/m² and has a mesh size of about 10 mm. The surfaces are kept apart by pile threads which, as a result, give the fabric a certain compressive strength with simultaneous high flexibility and resilience. The piece of fabric with a size of 200 mm×200 mm was cut out and placed into a mould with dimensions of 200 mm×200 mm×10 mm and with a one-ply transparent PE film inlay for visual assessment and simple demoulding. The previously prepared heat-insulating Formulation 1 was rubbed into the fabric by means of a board inclined at 45° with respect to the fabric surface. Said board was brushed over the fabric 2 times in each direction (left-right and top-bottom) at a speed of 200 mm per 10 seconds. While doing so, continuous care was taken that sufficient heat-insulating formulation was available for the filling of the fabric, which formulation was immediately replenished if necessary. After the filling was completed, the excess formulation was removed from the fabric by gently clearing it away using a spatula. During the filling process, the spacer fabric could be filled with the formulation without any difficulties and to a complete extent (degree of filling of virtually 100%) without deformation. The sample thus obtained was removed with PE film and then dried/cured for 7 days at 25° C. and 50% air humidity. The cured product exhibited no cavities or cracks, and the original geometry and volume of the fabric were maintained. The thermal conductivity of the cured product measured using a plate apparatus (EP500, manufacturer: lambda Messtechnik Dresden) at 10° C. mean temperature and 15 K temperature difference and a contact pressure of 2500 Pa was 41.4 mW/(m*K). The most important parameters in carrying out Example 1 are summarized in Table 1 below.

### COMPARATIVE EXAMPLE 1

In this example, Thinsulate® G80 (manufacturer: 3M) with mesh size estimated 0.1 mm was used as porous substrate. The filling of said substrate (200 mm×200 mm×11 mm cut-out) with the heat-insulating Formulation 1 was carried out identically to the procedure described in Example 1. In this case, the fabric could nowhere near be completely filled (degree of filling of 15.6%, based on the original thickness) and it deformed and compressed heavily upon filling. After the curing of the partly filled material for 7 days at 25° C. and 50% air humidity, visual assessment was carried out. In said assessment, it was found that the depth of penetration of the heat-insulating formulation into the fabric was not more than 2 mm, whereas the bottom side of the fabric remained unfilled. This material is unusable for an efficient heat insulation. The most important parameters in carrying out Comparative Example 1 are summarized in Table 1 below.

### COMPARATIVE EXAMPLE 2

In this example, BawiTec-Badewien fibreglass fabric (fly screen, black, PVC-coated, rolled product, width: 120 cm, length: 30 m) with mesh size 1.4 mm×1.4 mm was used as porous substrate. Multiple pieces of fabric of size 200 mm×200 mm were cut out and combined to achieve a total stack thickness of about 10 mm. Said stack composed of multiple fabric layers was placed into a mould with dimensions of 200 mm×200 mm×10 mm. The filling of this substrate with the heat-insulating Formulation 1 was carried out identically to the procedure described in Example 1. In this case, the fabric could nowhere near be completely filled (degree of filling 22%), but it did not deform or compress upon filling. After the curing of the partly filled material for 7 days at 25° C. and 50% air humidity, visual assessment was carried out. In said assessment, it was found that the depth of penetration of the heat-insulating formulation into the fabric was not more than 8 of altogether 38 plies used, whereas the remaining plies situated toward the bottom side (direction of PE film) of the stack remained unfilled. This material is unusable for an efficient heat insulation. The most important parameters in carrying out Comparative Example 2 are summarized in Table 1 below.

TABLE 1

| | Example 1 | Comparative | Comparative |
|---|---|---|---|
| | Spacer fabric, Müller | Example 1 | Example 2 |
| | textiles | Thinsulate, 3M | Fibreglass fabric, |
| Porous substrate | T5993-1000 | G80 | BawiTec |
| Mesh size, mm | 10 | 0.1 | 1.4 |
| Number of plies | 1 | 1 | 38 |
| Basis weight, g/m² | 520 | 80 | 109 |
| Thickness of | 10 | 11 | 0.263 |
| individual ply, mm | | | |
| Thickness of stack, | 10 | 11 | 10 |
| mm | | | |
| Density, kg/m³ | 52 | 7.3 | 415 |
| Compression stress | 8.5 | <0.1 | >100 |
| (DIN EN ISO 3386-1), | | | |
| kPa | | | |
| Porosity, % | 96.2 | 99.5 | 79.3 |
| Empty volume for 20 | 385 | 398 | 317 |
| cm × 20 cm × 1 cm | | | |
| mould, cm³ | | | |
| Weight of empty | 21 | 3.2 | 156 |
| fabric, g | | | |
| Volume of filled fabric, | 388 | 62 | 71 |
| cm³ | | | |
| Weight of maximally | 202 | 33 | 190 |
| filled fabric, g | | | |
| Degree of filling with | 100 | 15.6 | 22 |
| regard to original | | | |
| porosity, % | | | |
| Thermal conductivity, | 41.4 | Not measured | Not measured |
| mW/(m*K) | | (incomplete filling) | (incomplete filling) |

Use of the spacer fabric as a porous substrate (Example 1) showed major advantages compared to the other types of fabric (Comparative Examples 1 and 2), since the spacer fabric is completely fillable in a very simple manner. Such complete filling ensures a low thermal conductivity, which is required for use in heat insulations. In addition, the use of the spacer fabric does not result in any cavities or cracks, which would increase the risk of corrosion at the insulating materials. Both the relatively wide mesh size of the spacer fabric used (10 mm) and the great mechanical strength of this material exhibit an additional advantageous effect in comparison with the other types of fabric tested.

### EXAMPLE 2

In this example, the spacer fabric from Müller Textiles, 51674 Wiehl, Germany, called T5960-2000-2000-0001 and made of 100% polyester, was used. This structure has a thickness of 20 mm, a basis weight of about 1080 g/m² and has cover layers with openings (mesh size) in the range of 5 mm diameter. The surfaces are kept apart by pile threads which, as a result, give the fabric a certain compressive strength with simultaneous high flexibility and resilience. Correctly dimensioned and as a single layer, said spacer fabric was placed around a metal pipe having an inner diameter of 120 mm, a wall thickness of 1 mm and a length of 250 mm and fixed at the butt seam/edge using a sewing thread, and so the spacer fabric fits tightly around the pipe.

Next, heat-insulating Formulation 2 was manually mixed using a spatula until there was a homogeneous mixture consisting of:

1 part expanded glass granulate as bulk material having a particle density of 350 g/l and a thermal conductivity of 70-80 mW/(m*K) from Liaver, for details see: R. Schreiner, E.-G. Hencke, “Characterization Work and Comparative Testing of Expanded Glass Granulate as a Round Robin Material for Thermal Conductivity at Higher Temperatures, International Journal of Thermal Sciences”, DOI 10.5703/1288284315540. 5 parts RTV silicone (brand b1—better savings, transparent silicone, contains biocidal/fungicidal coat preservative (2-octyl-2H-isothiazol-3-one)).

Said heat-insulating Formulation 2 was then brushed and pressed into the spacer fabric by means of a spatula. Oscillating movements were found to be the best. Thereafter, this pipe specimen was cured at room temperature for 5 days. Then, the pipe was sealed watertight at one opening using a faceplate and filled with water while standing perpendicularly. The water temperature in the pipe was adjusted to 80° C. In the steady state, i.e. after the heating and adjustment of the target water temperature, the temperature of the insulated outer surface of the pipe was determined as 40° C. on the middle of the pipe length using a pyrometer. This experiment took place in a laboratory without forced convection and at air temperatures of 22° C.

Example 2 shows that the process according to the invention makes it possible to apply a heat-insulating layer of 20 mm thickness to a pipe in a very simple and practical manner.

1-12. (canceled)

13. A process for applying a heat-insulating layer to a surface of an article, which surface is to be insulated, comprising the following steps:
a) applying a porous substrate consisting of a spacer fabric to the surface to be insulated;
b) filling the porous substrate applied in step a) with a heat-insulating formulation;
c) curing the formulation filled in step b).

14. The process of claim 13, wherein the article having the surface to be insulated is selected from the group consisting of wall, ceiling, floor, plate, pipeline and pipe.

15. The process of claim 13, wherein the porous substrate is flexible.

16. The process of claim 15, wherein the porous substrate is selected from the group consisting of synthetic polymers, cellulose-based fibres, cotton, wool, silk, mineral wool, glass wool, metals, carbon fibres and the combinations thereof.

17. The process of claim 13, wherein the spacer fabric has a mesh size of from 2 to 100 mm.

18. The process of claim 13, wherein the porous substrate in step a) is attached mechanically and/or by means of an aid to the surface to be insulated.

19. The process of claim 13, wherein the heat-insulating formulation comprises a binder containing polymerizable substances and/or water.

20. The process of claim 13, wherein the heat-insulating formulation contains silica.

21. The process of claim 13, wherein the heat-insulating formulation contains at least one IR opacifier.

22. The process of claim 13, wherein the heat-insulating formulation contains from 5 to 90% by weight of a binder, from 20 to 95% by weight of a silica, and from 5 to 50% by weight of an IR opacifier.

23. The process of claim 13, wherein the curing taking place in step c) is achieved by at least partial polymerization and/or vaporization of the water.

24. The process of claim 13, wherein the heat-insulating layer after curing has a thickness of more than 1 mm.

25. The process of claim 14, wherein the porous substrate is flexible.

26. The process of claim 25, wherein the porous substrate is selected from the group consisting of synthetic polymers, cellulose-based fibres, cotton, wool, silk, mineral wool, glass wool, metals, carbon fibres and the combinations thereof.

27. The process of claim 26, wherein the spacer fabric has a mesh size of from 2 to 100 mm.

28. The process of claim 27, wherein the porous substrate in step a) is attached mechanically and/or by means of an aid to the surface to be insulated.

29. The process of claim 26, wherein the heat-insulating formulation comprises a binder containing polymerizable substances and/or water.

30. The process of claim 26, wherein the heat-insulating formulation contains silica.

31. The process of claim 26, wherein the heat-insulating formulation contains at least one IR opacifier.

32. The process of claim 26, wherein the heat-insulating formulation contains from 5 to 90% by weight of a binder, from 20 to 95% by weight of a silica, and from 5 to 50% by weight of an IR opacifier.
